(19) United States
(12) Patent Application Publication
(10) Pub. No.: US 2012/0296717 A1
(43) Pub. Date: Nov. 22, 2012

(54) Lucky Day Rewards Program

(76) Inventor: Steven Jeffrey Katzman, Fort Myers, FL (US)

(21) Appl. No.: 13/108,662

(22) Filed: May 16, 2011

(51) Int. Cl. G06Q 30/00

(52) U.S. Cl. 705/14.14

(57) ABSTRACT

A Lucky Day Rewards according to the present invention is a loyalty and rewards program that does not require customers to keep track of miles or points. Customers pay nothing to participate in the program. The Lucky Day Rewards program awards the loyal customers based on purchases made within a defined period of time. The purchase is rewarded faster than other type of reward program which may require accumulation for a long period of time for a valuable redemption. On the first day of each month, a random number is generated by spinning a wheel containing 31-numbers, or the like. The number it lands on is the winning day for the previous month. Anyone who purchased anything at a participating business entity during the previous month simply brings back their receipt to the stores or mails the receipt or enters their customer number or receipt number online for a partial or full credit.

### BACKGROUND OF THE INVENTION

1. Field of the Invention

The present invention generally relates to reward programs, and more specifically to a Lucky Day Rewards program that is based on a random number generated by a spin wheel and/or the like.

2. Description of Related Art

Rewards programs are conventionally offered by merchants to customers via coupons, points programs, gift cards, store credits, and the like, so that the customers can use these rewards for doing future business with the same merchants. Such a program is expected to provide customers an incentive to repeatedly do business with a merchant, helping to create customer loyalty. However, awarding coupons, gift cards, store credits to all customers on a routine basis may reduce the value of these rewards that the merchant can afford. Thus, getting these rewards may not seem like a lot of incentives to a customer.

In order to attract and retain customers, airlines, hotels, car rental companies, telephone companies, etc. offer customers frequent use programs that allow accumulation of points, such as “frequent flyer miles”. Because the rewards are based on accumulated points, the rewards offered will be more valuable. However, the reward level may require accumulation for a long period of time for a valuable redemption and thus seem out of reach to the customer. As a result, the customers do not expect that they will reach that level; the reward programs are not as attractive as they could be.

Therefore, there is a need for a rewards program that will cause more excitement for the customer due to the higher value of the rewards and the shorter period of time for realizing the reward.

### SUMMARY OF THE INVENTION

One object of the present invention is to provide a reward program that does not require customers to keep track of miles or points.

Another object of the present invention is to provide a reward program that customers pay nothing to participate in the program.

Still another object of the present invention is to provide a reward program that customers are not required to sign up or register if they elect not to.

Yet another object of the present invention is to provide a reward program that will cause more excitement due to the value of the reward and shorter period of time for realizing the reward.

Lucky Day Rewards according to the present invention is a loyalty and rewards program that does not require customers to keep track of miles or points. Customers pay nothing to participate in the program.

The Lucky Day Rewards program motivates customers to stay loyal to the business entity by giving customers incentives for their loyalty. The Lucky Day Rewards program awards the loyal customers based on purchases made within a defined period of time. Because the reward is only awarded to the customers who purchased on the lucky day the value of the reward could be higher than fixed type of reward program. Moreover, the purchase is rewarded faster than other types of reward programs which may require accumulation for a long period of time for a valuable redemption. The Lucky Day Rewards program rewards customers based on purchases made within a short-term interval. Customers' right to win reward is renewed periodically; it may be monthly.

On a day of each month, Lucky Day Rewards program management spins a wheel containing 31-numbers. The number it lands on is the winning day for the previous month. Anyone who purchased anything at a participating business entity during the previous month simply brings back their receipt to the stores or mails the receipt to the Lucky Day Rewards management or enters their customer number or receipt number online for a partial or full credit. If the months has fewer than 31 days and the wheel lands on an invalid number, the wheel is spun again and again until a valid number comes up.

In one embodiment, an individual business entity may adopt the Lucky Day Rewards program system and method of the present invention and maintains the reward program within the business entity either at the store or online.

In another embodiment, the business entities may participate in the Lucky Day Rewards program that is maintained and managed by a third party company. This business model is suitable for the business entities that do not have a physical store for customers to walk in and/or the business entities that do not want to dedicate resource to manage the reward program. The program is supported entirely by the participating business entities. Payments from the participating business entities to the Lucky Day Rewards program may be made in cash and/or in the form of barter such as gift certificates, etc. which may be sold off to the public to convert it into working capital.

An individual business with an online store that adopts the Lucky Day Rewards program system and method may pay a royalty fee and utilize their own internal database setup to store receipt numbers or internal customer numbers associated with each purchase. An internal Lucky Day Rewards program system (independent from Lucky Day Reward's own system and database) may be setup to determine which customer numbers/receipt numbers made purchases on the lucky day randomly generated for the previous month. An internal Lucky Day Rewards box may be setup on the participating business entity's website for the customer to enter their customer number/receipt number which will be evaluated/processed by the internal Lucky Day Rewards program system and if the customer is indeed a reward winner, then a credit redeem code will be displayed on the business entity website or Lucky Day Rewards website. The participating business entities may elect to receive customer's claim and receipts by mail and send gift card or certificate to winning customers by mail.

If an individual business with an online store does not have an internal database to store receipt numbers or internal customer numbers associated with each purchase then they may pay for the usage of the Lucky Day Rewards database. This means a bridging system needs to be implemented to connect the participating business website with the Lucky Day Rewards system. Once a purchase is made, the online store will notify the Lucky Day Rewards system and a Lucky Day Rewards customer number will be generated and store in the Lucky Day Rewards database. A Lucky Day Rewards box may be setup on the participating business entity's website for the customer to enter their customer number/receipt number which will be sent to the Lucky Day Rewards program system to be evaluated/ processed. If the customer is indeed a reward winner, then a credit redeem code will be displayed on the business entity. The participating business entities may elect to receive customer's claim and receipts by mail and send gift card or certificate to winning customers by mail.

Alternatively, an online store can have information on their websites to inform their customers on how to visit the Lucky Day Rewards website if their online store webpage do not provide a box to enter the Lucky Day Rewards customer number that communicates with the Lucky Day Rewards system and database. On the Lucky Day Rewards website there will be a Lucky Day Rewards box for the customer to enter their customer number/receipt number which will be evaluated/processed and if the customer is indeed a reward winner, then a credit redeem code will be displayed on the Lucky Day Rewards website. The participating business entities may elect to receive customer's claim and receipts by mail and send gift card or certificate to winning customers by mail.

For the aforementioned embodiments, the Lucky Day Rewards program requires no signup, no registration.

In another embodiment, the Lucky Day Rewards system may determine all the customers that bought merchandises on the lucky day of the past month and automatically distribute rewards to these winners. However, to do this the Lucky Day Rewards system will have to have customer email addresses and the capability of storing customer email addresses with their customer numbers. The online affiliated business's website should provide a page or redirect to Lucky Day Rewards website for customers to sign up for the Lucky Day Rewards system informing the customers of the benefit of signing up (or just providing e-mail address) with the Lucky Day Rewards system which automatically sends credit redemption code to the customer's email if they are a Lucky Day Rewards winner. If the customer does not sign up then they will have to enter their customer number within the time period after the lucky day is drawn and before the period to claim the credit redemption code expires.

The business system and method may include any business entity, such as retailers, distributors, manufacturers, stores, supermarkets, pharmacies, online merchants, airlines, banks, gas station, hotels, etc.

In one embodiment, a method for operating the Lucky Day Rewards comprises the steps of: generating a lucky day number by spinning a wheel containing 31-numbers or the like, the number it lands on is the winning day for the previous month; qualifying a customer for a reward in the reward program by verifying the receipts that the customer brings to the stores or submits to the Lucky Day Rewards management by mail; and awarding the reward to the customers in the Lucky Day Rewards program if the customer is qualified.

In another embodiment, a method for operating the Lucky Day Rewards comprises the steps of: establishing a database to store the customers' purchase information; randomly generating a lucky day number; qualifying customers for a reward in the reward program by comparing the customer number that the customers enter into the system online; and awarding the reward (e.g. credit redeem code) to the customers in the Lucky Day Rewards program if the customer is qualified.

In another embodiment, the method further comprises the steps of receiving customers' purchase information from the participating business entity before establishing database of purchase information.

In one embodiment, a system for operating the Lucky Day Rewards comprises: a means such as spinning wheel containing 31-numbers and/or the like for generating a lucky day number; a means to verify the customers' receipts that the customers brought to the store or mailed to the Lucky Day Rewards program management; and a means to provide the gift card or gift certificate to qualified customers in store or by mail.

In one embodiment, a system for operating the Lucky Day Rewards comprises: a database that receives and stores customer's purchase information including customer number/receipt number, date of purchase, amount of purchase in dollars; spinning wheel containing 31-numbers and/or the like for generating a lucky day number; a website with user interface for the customers to enter customer number; means for verifying whether the day the customer number is stored under is the winning lucky day number; and means for generating a credit redemption code.

The Lucky Day Rewards system comprises a database. Each purchase made in a participating business is assigned a customer number and grouped with the amount spent in the database under a date filing system. When a customer enters their customer number to see if they are a lucky day winner, the customer number input is searched within the database and the date of purchase it's under is retrieved and compared to the lucky day generate to see if it's the same date. If it is, the amount spent corresponding with the customer number will also be retrieved to determine the proportional credit to be given to the winner. A redeemable credit code assigned to the determined credit is returned and displayed to the user on the website.

In one embodiment, the Lucky Day Rewards program system further comprises a unit that deals with the gift certificate paid by the participating business entities to the Lucky Day Rewards program management company for public sale to convert the gift certificate into working capital.

The customers will be more enticed by the lucky day program compared to other programs due to the fact that anyone that made a purchase can win since the lucky day is randomly chosen. However, customers will have a higher chance of winning the lucky day if they shop more frequently and that the amount of credit returned is proportional to the amount they spent on the lucky day. This will lead to increases in purchasing of a business entity's services and/or commodities.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow chart illustrating an embodiment of the reward program that applies to the customer made purchases from the business entities that have walk-in stores;

FIG. 2 is a flow chart illustrating an embodiment of the reward program that the individual business entity utilizes its own database;

FIG. 3 is a flow chart illustrating an embodiment of the reward program that the participating business entity utilizes Lucky Day Rewards System; and

FIG. 4 is a flow chart illustrating an embodiment of the reward program system of the present invention.

### DESCRIPTION OF THE PREFERRED EMBODIMENT

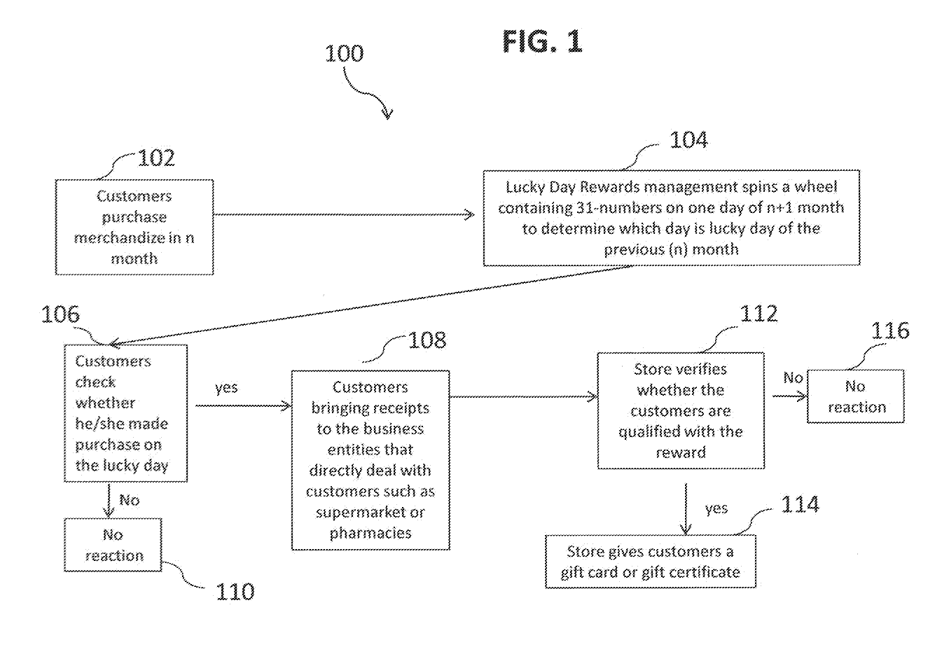

Referring to FIG. 1, there is disclosed a flow chart 100 of the Lucky Day Rewards program of the present invention for a purchase made from the business entities that have direct contact with customers such as supermarket and pharmacies, etc. When the customers make a purchase from business entities in “n” month (step 102), the customers automatically have the right to participate in the Lucky Day Rewards program without making any payment to the program. On one day of the next month (n+1), it is preferred on the first day of the next month, the Lucky Day Rewards system will generate a lucky day number by spinning a wheel containing 31-numbers or the like to determine which day is the lucky day of the previous (n) month (step 104). Customers may check the Lucky Day in the store to see whether they purchased commodities or services on the lucky day (step 106). If yes, the customers may simply bring the receipts to the stores (step 108). The stores will then verify whether the purchase is made on the lucky day (step 112). If yes, the store will give customers gift certificate (step 114). The advantage of the business method is simple and convenient for the customers.

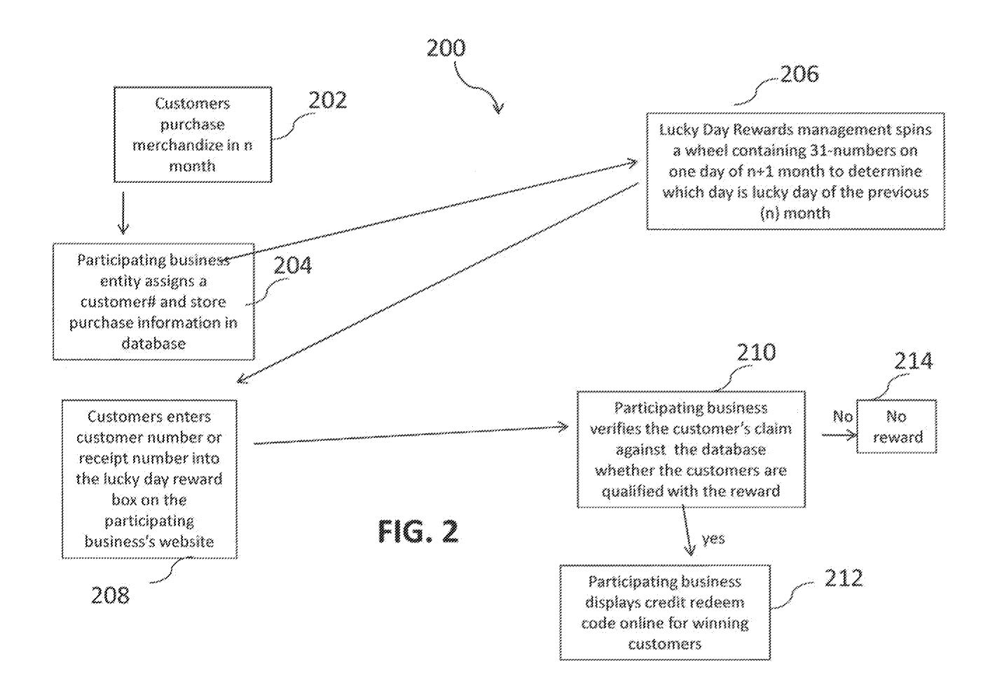

FIG. 2 depicts an embodiment flow chart 200 of the Lucky Day Rewards program operated by an online store utilizing their own internal database setup to store receipt numbers or internal customer numbers associated with each purchase. When a customer purchases (step 202) at an individual business, the business entity assigns receipt number or internal customer number associated with the purchase to the customer and store these information in their internal database (step 204). An internal Lucky Day Rewards program system (independent from Lucky Day Reward's own system and database) may be setup to determine which customer numbers/receipt numbers made purchases on the lucky day randomly generated for the previous month (step 206). An internal Lucky Day Rewards box may be setup on the participating business entity's website for the customer to enter their customer number/receipt number (step 208) which will be evaluated/processed by the internal Lucky Day Rewards program system (step 210) and if the customer is indeed a reward winner, then a credit redeem code will be displayed (step 212) on the business entity website or Lucky Day Rewards website. The participating business entities may elect to receive customer's claim and receipts by mail and send gift card or certificate to winning customers by mail.

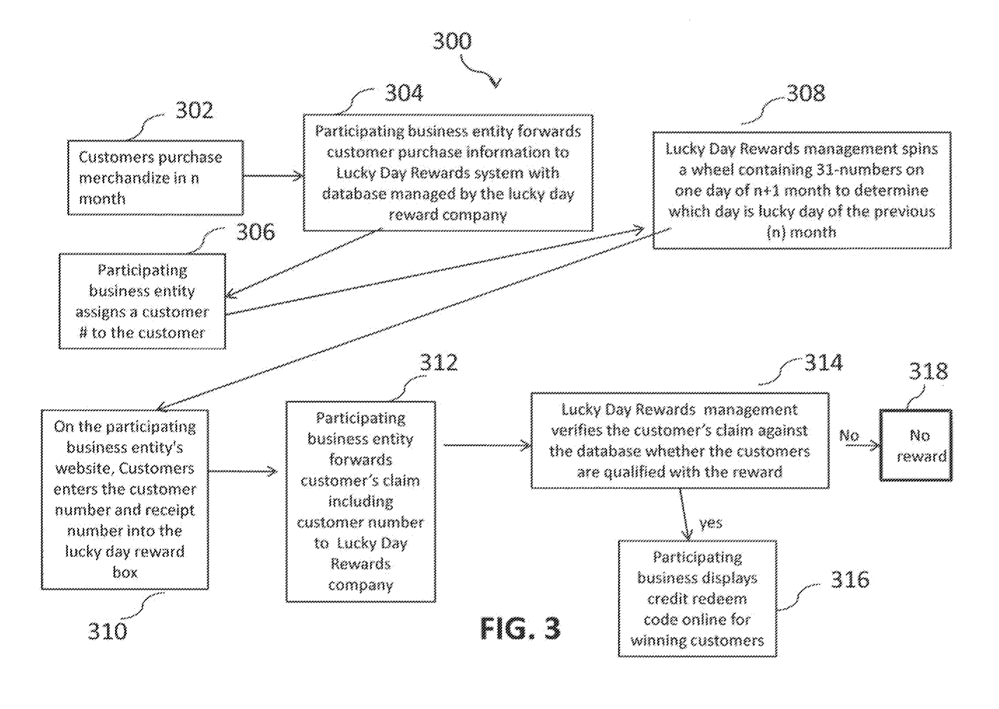

Referring to FIG. 3, there is disclosed an embodiment 300 of the Lucky Day Rewards program for an online store that does not have an internal database to store receipt numbers or internal customer numbers associated with each purchase so that they may pay for the usage of the Lucky Day Rewards database managed by a third party company. Once a purchase is made (step 302), the online store will notify the Lucky Day Rewards system and a Lucky Day Rewards customer number will be generated and stored in the Lucky Day Rewards database (steps 304 and 306). A lucky day will be generated randomly (step 308). A Lucky Day Rewards box may be setup on the participating business entity's website for the customer to enter their customer number/receipt number (step 310) which will be sent to the Lucky Day Rewards program system to be evaluated/ processed (steps 312 and 314). If the customer is indeed a reward winner, then a credit redeem code will be displayed on the business entity (step 316). The participating business entities may elect to receive customer's claim and receipts by mail and send gift card or certificate to winning customers by mail.

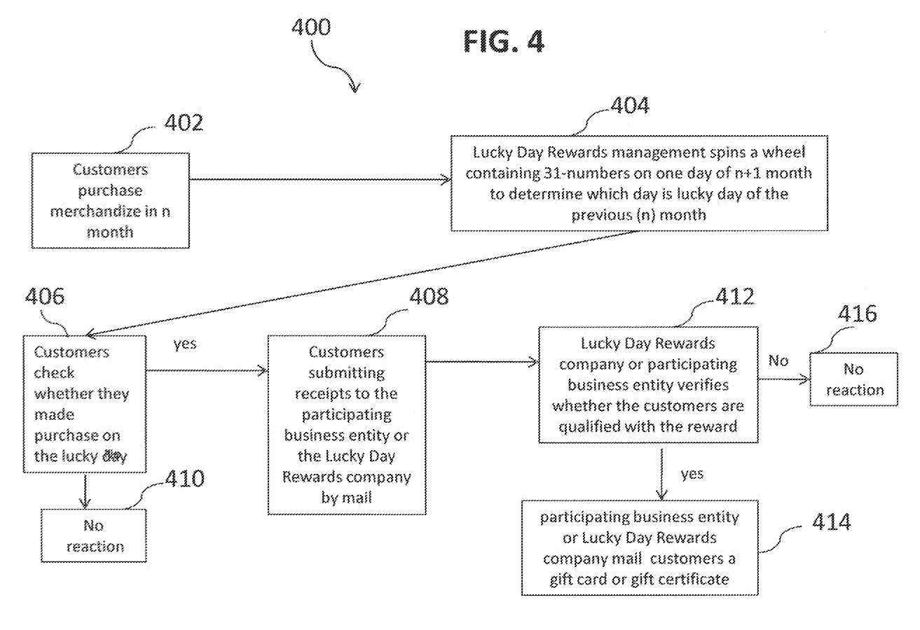

If the online stores or the Lucky Day Rewards company does not offer online customer number input, refer to the flow chart 400 disclosed in FIG. 4. The customers may claim the reward by mailing the receipt to the business entities or the Lucky Day Rewards company (step 408). After verifying the information, the participating business entity or Lucky Day Rewards company may mail customers a gift card or gift certificate (step 414).

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for operating a Lucky Day Rewards comprising the steps of: randomly generating a lucky day number; qualifying a customer for a reward in the reward program; and awarding the reward to the customers in the Lucky Day Rewards program if the customer is qualified.

2. The method of claim 1, wherein the lucky day number is generated by spinning a wheel containing 31-numbers, the number it lands on is the winning day for the previous month.

3. The method of claim 1, wherein the lucky day number may be generated by other means.

4. The method of claim 1, wherein the customer for a reward is qualified by examining the receipt that the customer brings to the stores or submits to the Lucky Day Rewards program by mail to determine whether the purchase occurred on the lucky day.

5. The method of claim 1, wherein the reward may be in the form of store credit, a gift certificate, or a gift card.

6. A method for operating a Lucky Day Rewards comprising the steps of: establishing database to store the customers' purchase information; randomly generating a lucky day number; qualifying a customer for a reward in the reward program; and awarding the reward to the customers in the Lucky Day Rewards program if the customer is qualified.

7. The method of claim 6 further comprising the steps of receiving customers' purchase information.

8. The method of claim 6, wherein the lucky day number is generated by spinning a wheel containing 31-numbers, the number it lands on is the winning day for the previous month.

9. The method of claim 6, wherein the lucky day number may be generated by other means.

10. The method of claim 6, wherein the customers' purchase information including purchase date, customer number, and amount spent.

11. The method of claim 6 further comprising the step of setting up a Lucky Day Rewards box on the participating business entity's website for the customers to enter their customer number which will be processed/evaluated internally against the database of the customers' purchase information; and displaying a credit redeem code on the business entity website if the customer is indeed a reward winner.

12. The method of claim 6 further comprising the step of setting up a Lucky Day Rewards box on the participating business entity's website for the customers to enter their customer number which will be forwarded to the Lucky Day Rewards website to be processed/evaluated internally against the database of the customers' purchase information; and displaying a credit redeem code on the business entity website if the customer is indeed a reward winner.

13. The method of claim 6 further comprising the step of setting up a Lucky Day Rewards box on the Lucky Day Rewards website there for the customer to enter their customer number which will be processed/evaluated against the database of the customers' purchase information; and displaying a credit redeem code on the Lucky Day Rewards website if the customer is indeed a reward winner.

14. The method of claim 6 further comprising the step of notifying the winning customers after the Lucky Day Rewards system determines all the customers that bought merchandises on the lucky day of the past month; and automatically distributes rewards to these winners providing the system has customer's email or mailing address.

15. The method of claim 6 further comprising the step of dealing with the gift certificate paid by the participating business entities to the Lucky Day Rewards program management company for public sale to convert the gift certificate into working capital.

16. A system for operating the Lucky Day Rewards comprises: a database that receives and stores customer's purchase information including customer number/receipt number, date of purchase, amount of purchase in dollars; spinning wheel containing 31-numbers and/or the like for generating a lucky day number; a website with user interface for the customers to enter customer number; means for verifying whether the day the customer number is stored under is the winning lucky day number; and means for generating a credit redemption code.

17. The system of claim 16 wherein the Lucky Day Rewards system comprises a database, each purchase made in a participating business is assigned a customer number and grouped with the amount spent in the database under a date filing system. When a customer enters their customer number to see if they are a lucky day winner, the customer number input is searched within the database and the date of purchase it's under is retrieved and compared to the lucky day generate to see if it's the same date. If it is, the amount spent corresponding with the customer number will also be retrieved to determine the proportional credit to be given to the winner. A redeemable credit code assigned to the determined credit is returned and displayed to the user on the website.
